(19) United States
(12) Patent Application Publication
(10) Pub. No.: US 2010/0035136 A1
(43) Pub. Date: Feb. 11, 2010

(54) BATTERY FIXING APPARATUS AND ELECTRONIC DEVICE USING THE SAME

(75) Inventors: Da-Wei Huang, Shenzhen City (CN); Song-Ling Yang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Tu-Cheng (TW); HON HAI PRECISION CO., LTD., Tu-Cheng (TW)

(21) Appl. No.: 12/486,723

(22) Filed: Jun. 17, 2009

(30) Foreign Application Priority Data
Aug. 11, 2008 (CN) 200810303665.4

(51) Int. Cl. H01M 2/10

(52) U.S. Cl. 429/100

(57) ABSTRACT

A battery fixing apparatus for fixing a battery in a housing of an electronic device is provided. The fixing apparatus includes a bracket and a fixing member accommodated in the housing. The bracket includes two protruding portions, and each protruding portion defines a slot. The protruding protrusions move out or in from an opening of the housing. The fixing member is used for receiving the battery. The fixing member further includes two locking parts protruded from inner surface of the fixing member. The locking parts pass through the slot and are locked into limiting grooves of the battery, and then, deform elastically and separated from the limiting grooves while pressed by the protruding portions.

### BACKGROUND

1. Technical Field

The disclosure relates to a fixing apparatus for fixing a battery in an electronic device.

2. Description of Related Art

Mobile phones are now considered necessary in daily life. When a user replaces the battery in his or her phone with another one, the user often has to open the rear cover of the phone to retrieve the battery. Currently, the rear cover of many mobile phones is mated with a protrusion which makes the rear cover attach to the front cover of the mobile phone, when retrieving the battery, the user must press the protrusion so as to detach the rear cover from the front cover. However, the protrusion may wear out or break over time and after repeated use, as a result, the rear cover may not be attached back to the front cover of the mobile phone after the battery being replaced. Therefore, what is needed is an electronic device with more reliable access to a battery thereof.

### BRIEF DESCRIPTION OF THE DRAWINGS

The components of the drawings are not necessarily drawn to scale, the emphasis instead being placed upon clearly illustrating the principles of an electronic device. Moreover, in the drawings, like reference numerals designate corresponding parts throughout several views.

FIG. 1 is a perspective view of an electronic device including a battery fixing apparatus in accordance with a preferred embodiment.

FIG. 2 is an exploded perspective view of the battery fixing apparatus installed in the electronic device shown in FIG. 1.

FIG. 3 is a cross-sectional view of the battery fixing apparatus in a state of fixing a battery.

### DETAILED DESCRIPTION

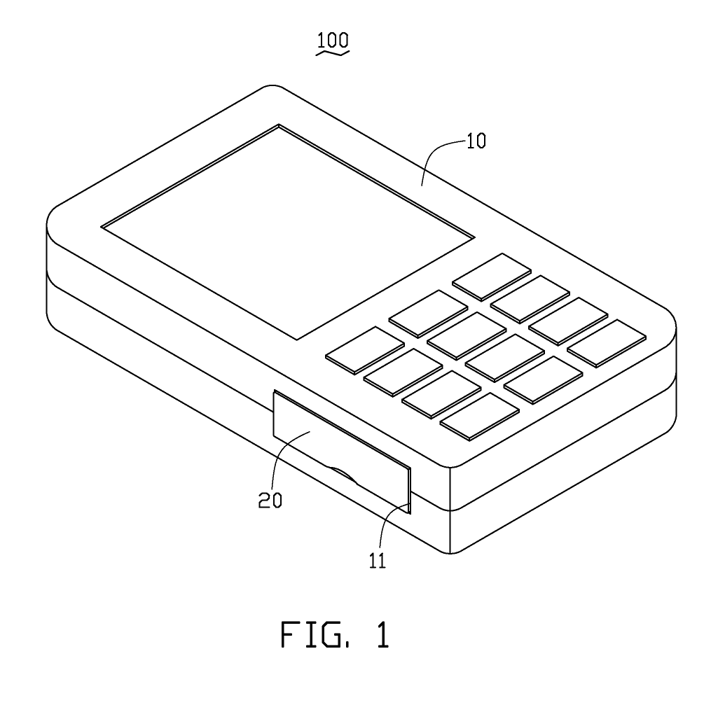

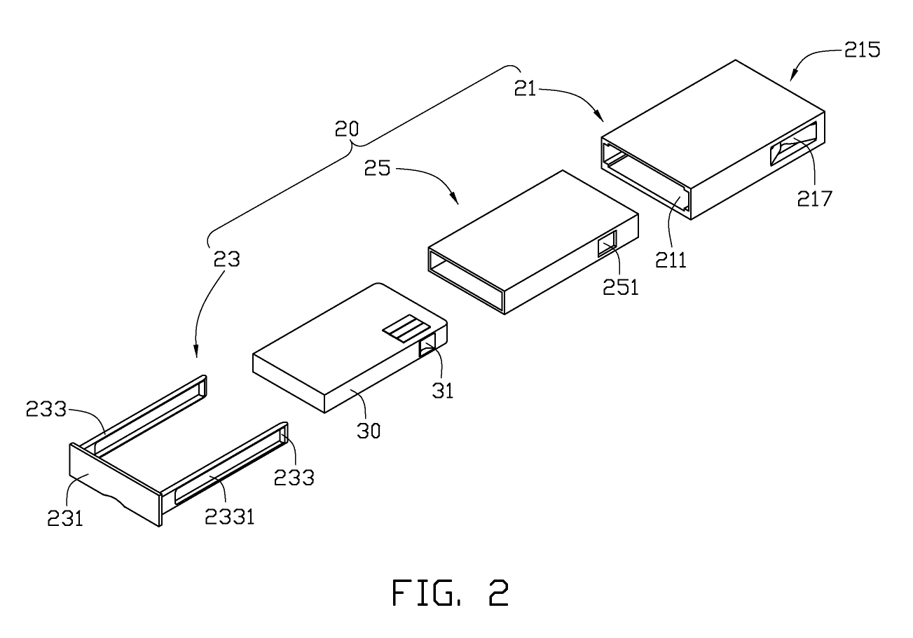

FIG. 1 is a perspective view of an electronic device including a battery fixing apparatus in accordance with a preferred embodiment. The electronic device 100 includes a housing 10, a battery fixing apparatus 20, and a battery 30 (shown in FIG. 2). The battery fixing apparatus 20, securely connected to the housing 10, is configured to fix the battery 30 in place in the electronic device 100. The housing 10 defines an opening 11 for accommodating the battery fixing apparatus 20.

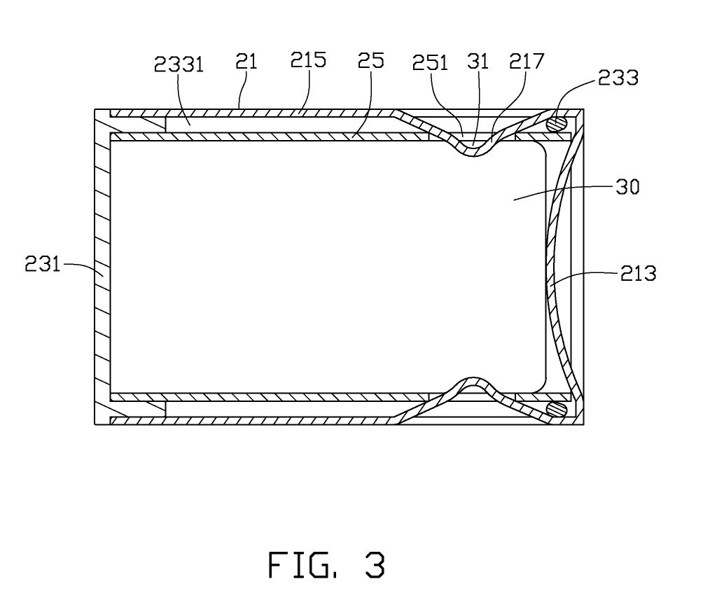

Referring to FIG. 2 and FIG. 3, the battery fixing apparatus 20 includes a fixing member 21, a bracket 23, and a retaining member 25.

The fixing member 21, attached to inside of the housing 10, is hollow with an open end 211. The fixing member 21 includes an assistant portion 213 protruded from an inner surface of the fixing member 21 in the opposite of the open end 211. The assistant portion 213 deforms elastically while being compressed. The fixing member 21 further includes two locking parts 217 protruded from an inner surface of each sidewall 215. The locking parts 217 are curved spring clips, both ends of each locking part 217 connect to the inner surface of the sidewall 215, and the locking parts 217 deform elastically while being depressed.

The bracket 23 is configured for removing the battery 30 from the electronic device 100. The bracket 23 includes a faceplate 231 and two protruding portions 233, wherein each protruding portion 233 is extended from one end of the faceplate 231 and perpendicular to the faceplate 231. The faceplate 231 is configured for covering the opening 11 of the housing 10. The protruding portion 233 is strip-shaped and made of soft resilient material. Each protruding portion 233 defines a slot 2331, wherein the locking parts 217 can pass through the slots 2331.

The retaining member 25 for receiving the battery 30, is a hollow rectangular parallelepiped with two open ends and is accommodated in the fixing member 21, and the protruding portions 233 are sandwiched between ends of the retaining member 25 and the fixing member 21. The retaining member 25 defines two through holes 251 corresponding to the positions of the locking parts 217, and the locking parts 217 can pass through the through holes 251.

The battery 30, accommodated in the retaining member 25, defines two limiting grooves 31 in opposite sides corresponding to the positions of the through holes 251.

To install the battery 30 in the electronic device 100, firstly, pull the bracket 23 out and install the battery 30 into the bracket 23; then, push the bracket 23 into the fixing member 21, accordingly, the battery 30 is received in the retaining member 25. As pressed by the battery 30 and the protruding portions 233, the locking parts 217 deform elastically so that the battery 30 and the bracket 23 can keep on sliding; while the slots 2331 are coplanar with the locking parts 217, the locking parts 217 rebound, pass through the slots 2331 and the through holes 251, and are locked into the limiting grooves 31, therefore, the battery 30 is fixed in the housing 10. At the same time, the assistant portion 213 of the fixing member 21 is elastically deformed by the battery 30.

To remove the battery 30 from the electronic device 100, firstly, pull the bracket 23, then the protruding portions 233 compress the locking parts 217 and the locking parts 217 deform elastically, as a result, the locking parts 217 are separated from the limiting grooves 31, at the same time, the assistant portion 213 rebounds, and the battery 30 is extruded from the retaining member 25. After user taken out the battery 30, the bracket 23 is pushed into the retaining member 25 again, the locking parts 217 pass through the through holes 251 and the slots 2331 and are locked with the fixing member 21.

By using the battery fixing apparatus 20, a user only needs to push and pull the bracket 23 to install and remove the battery 30, and does not need to open the housing 10, thereby avoiding damaging the housing 10 by opening the rear cover.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device, comprising:
a housing defining an opening;
a battery defining two limiting grooves in opposite sides; and
a battery fixing apparatus, configured for fixing the battery in the housing via the opening, comprising a bracket and a fixing member, wherein the bracket comprises two protruding portions; each protruding portion defines a slot; the protruding portions move out or in from the opening of the housing, the fixing member configured for receiving the battery, comprising two locking parts protruded from two opposite sides of an inner surface of the fixing member and corresponding to the limiting grooves and slots; the locking parts are configured to pass through the corresponding slots and lock into the corresponding limiting grooves; and the locking parts are also configured to deform elastically and separated from the limiting grooves while pressed by the protruding portions.

2. The electronic device as described in claim 1, wherein the fixing member is hollow with an open end for the bracket and the battery to pass through.

3. The electronic device as described in claim 1, wherein the bracket comprises a faceplate covering the opening of the housing.

4. The electronic device as described in claim 2, wherein the fixing member comprises an assistant portion; and the assistant portion is protruded from a side of the inner surface of the fixing member in the opposite of the open end, and deforms elastically while being compressed by the battery.

5. The electronic device as described in claim 4, wherein the fixing apparatus further comprises a retaining member for receiving the battery; the retaining member is accommodated in the fixing member and is a hollow rectangular parallelepiped with two open ends; the retaining member defines two through holes on opposite sides, respectively; and the locking parts pass through the through holes.

6. The electronic device as described in claim 5, wherein the protruding portions are sandwiched between ends of the retaining member and the fixing member.

7. A battery fixing apparatus, comprising:
a bracket, wherein the bracket comprises two protruding portions; each protruding portion defines a slot; and the protruding portions is configured to move out or in from an opening of a housing of an electronic device; and
a fixing member, configured for receiving a battery comprising two limiting grooves on opposite sides, respectively, comprising two locking parts protruded from two opposite sides of an inner surface of the fixing member and corresponding to the two limiting grooves and slots, the locking parts being configured to pass through the corresponding slots and lock into the corresponding limiting grooves, the locking parts being also configured to deform elastically and separated from the limiting grooves while pressed by the protruding portions.

8. The battery fixing apparatus as described in claim 7, wherein the fixing member is hollow with an open end for the bracket and the battery to pass through.

9. The battery fixing apparatus as described in claim 7, wherein the bracket comprises a faceplate covering the opening of the housing.

10. The battery fixing apparatus as described in claim 8, wherein the fixing member comprises an assistant portion; and the assistant portion is protruded from a side of the inner surface of the fixing member in the opposite of the open end, and deforms elastically while being pressed by the battery.

11. The battery fixing apparatus as described in claim 10, wherein the battery fixing apparatus further comprises a retaining member for receiving the battery; the retaining member is accommodated in the fixing member and is a hollow rectangular parallelepiped with two open ends; the retaining member defines two through holes on opposite sides, respectively; and the locking parts pass through the through holes.

12. The battery fixing apparatus as described in claim 11, wherein the protruding portions are sandwiched between ends of the retaining member and the fixing member.
